(19) United States
(12) Patent Application Publication
(10) Pub. No.: US 2025/0271584 A1
(43) Pub. Date: Aug. 28, 2025

(54) PROCESS AND REACTOR FOR REMOVING IMPURITIES FROM CARBON MATERIAL

(71) Applicant: HATCH LTD., Mississauga (CA)

(72) Inventors: Kamal Adham, Toronto (CA); Sabrina Antonia Francey, Etobicoke (CA); Andrew Peter Tohn, Ottawa (CA); Christopher John McIntyre, Mississauga (CA)

(21) Appl. No.: 18/557,476

(22) PCT Filed: Apr. 28, 2022
(86) PCT No.: PCT/CA2022/050653

§ 371 Date: Oct. 26, 2023

Related U.S. Application Data
(60) Provisional application No. 63/181,633, filed on Apr. 29, 2021.

(51) Int. Cl. G01V 1/28; G01V 1/30

(52) U.S. Cl. CPC G01V 1/282; G01V 1/302; G01V 2210/65; G01V 2210/663; G01V 2210/665

(57) ABSTRACT

A process and reactor for removing impurities from a carbon material, involving providing a carbon feed into the electrothermal reactor; providing a gas into the reactor; passing the carbon feed through the reactor in a direction; heating the carbon feed using one or more electrodes; volatizing non-carbon material of the feed with the heat; and discharging the purified carbon material at the second location. So purified, the carbon material may be battery-grade. The feed may be passed through the reactor in a generally horizontal direction. The velocity of the feed in the reactor may be controlled to achieve a select resident time sufficient to volatize a desired amount of impurity. The process and reactor may be configured to inhibit back-mixing of the feed.

### FIELD

The present disclosure relates to removing impurities from carbon materials. The removal of impurities may be to generate high-purity carbon materials, such as battery-grade graphite.

### BACKGROUND

High purity carbon materials, such as graphite (99.95%), are required for battery production. Producing such high purity materials, however, can be both feasibly difficult and environmentally costly, as such purification processes tend to involve processes such as: (i) hydrometallurgy and, (ii) pyrometallurgy.

Hydrometallurgical purification includes acid-base methods which require reaction with base at high temperatures followed by acid leaching to remove impurities. Such methods are time-consuming and environmentally harmful. Hydrometallurgical purification also includes hydrofluoric acid (HF) treatments which involve reaction with HF to remove impurities. However, solutions of HF are highly corrosive, and exposure to such solutions can be fatal. Pyrometallurgy purification includes chlorination roasting and is a method requiring reaction with chlorine gas to remove impurities. While the efficiencies of such a method can be high, it is otherwise very expensive and difficult to manage the gasses which are expelled during the process.

An improved process for producing high purity carbon materials, such as graphite, is desired.

### BRIEF DESCRIPTION OF THE FIGURES

Embodiments of the present disclosure will now be described, by way of example only, with reference to the attached Figures.

FIG. 1 depicts a cross-sectional schematic view of a carbon feed being horizontally flowed through a reactor having a high aspect ratio, in accordance with an embodiment of the invention as described herein.

FIG. 2 depicts a transversal cross-sectional view of a high aspect ratio reactor as described herein.

FIG. 3 depicts a longitudinal cross-sectional view of a high aspect ratio reactor as described herein.

FIG. 4 depicts a magnified portion of the plate of FIG. 3 between cut lines A-A.

### DETAILED DESCRIPTION

The present invention is for a reactor and process for removing impurities from carbon materials, such as graphite. The process comprises passing a feed of carbon along an elongated reactor at a high temperature to volatilize and remove impurities in a continuous process. The reactor may comprise one or more electrodes to provide the high temperature within the reactor. The electrodes may heat the interior of the reactor to about 3000 degrees Celsius. The carbon feed may be passed in a generally horizontal direction along the length of the reactor.

The elongated reactor has a length to width aspect ratio that helps inhibit backflow of carbon material. For example, the elongated reactor may have a length to width aspect ratio between about 3:1 to about 10:1. The high length to width aspect ratio of the reactor, coupled with the horizontal flow of the carbon feed, may allow for improved control of all of the feed's residence time in the reactor.

The rate at which the feed is moved through the reactor may be controlled based on a number of factors and desired outcomes. For example, the rate may be controlled based on the initial impurity levels in the carbon feed. By having control over the rate of feed flow within the reactor, it may help ensure the feed (including each portion of the feed) has sufficient residence time in the reactor to volatilize and remove a sufficient amount of impurities to achieve a desired purity level while minimizing the residence time required for that level of purity. As such, the process may be usable with impure carbon feeds having, for example, upwards of 20% impurities. In the present context the term impurities refers to non-carbon material.

In an embodiment of the invention, the reactor and process are configured to help inhibit backflow and mixing of carbon material having different residence times. Residence time refers to the amount of time that certain material has been within the reactor. The longer the residence time, the higher the purity of that carbon material, up to a threshold purity or time. After the threshold, additional residence time may not result in any or a sufficient increase in purity of the carbon. Accordingly, it is preferable to only have certain carbon material reside in the reactor for only as long as it is necessary to achieve the desired carbon purity so as to maximize the rate of production of purified carbon. Inhibiting such back-mixing of carbon materials in a single vessel allows for a continuous process of treating the carbon material, and greater throughput, or maximization of throughput, of material that is of a desired purity. The long aspect ratio of the reactor, and/or the horizontal flow of the carbon feed within the reactor, may help to inhibit back-mixing of the feed within the reactor such that carbon material having different residence times remain relatively separated throughout the process despite being a fluid within a single vessel. As a result, the concentration of purified carbon material increases across the length of the reactor (from carbon-material inlet to carbon-material outlet), thereby helping produce a highly purified carbon material with the carbon-material making only one pass through the reactor in a continuous process. In some instances, the highly purified carbon material produced may be graphite, and the graphite may be about 99.95% pure. The graphite produced using this reactor or process may be suitable for use in battery production, such as lithium-ion batteries.

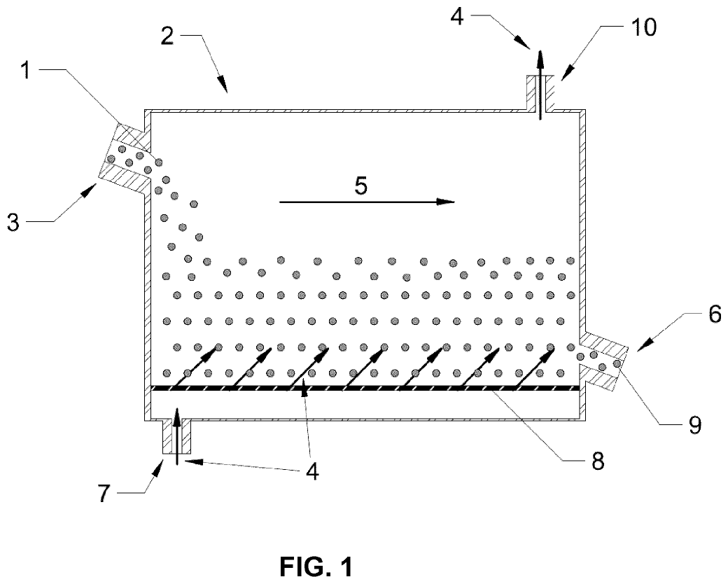

FIG. 1 shows a representation of a process and reactor for producing purified carbon material in accordance with and embodiment of the present invention. The process comprises providing a carbon feed 1 into an electrothermal reactor 2 having a high aspect ratio. A high aspect ratio generally refers to the ratio of length to width, where length is greater than width. The carbon feed 1 may comprise any one or more carbonaceous feedstocks with one or more impurities. The impurities may comprise 1% to 15%, or comprise upwards of 20% or more of an impurity by weight. As referred to herein, an impurity is a non-carbon material, including but not limited to silica, alumina, iron (Fe),), calcium (Ca), magnesium (Mg), aluminium (Al), oxygen (O), sulfur(S), or a combination thereof. In some embodiments, the carbon feed 1 may be a graphite feedstock. In one or more embodiments, the carbon feed may have a very fine grain size. The carbon feed 1 is provided into the reactor 2 via an inlet 3.

The process also comprises providing a gas 4 into the reactor 2. The gas 4 may be provided into the reactor 2 in such a manner so as to help flow the carbon feed 1 in a direction. The gas 4 may be used to horizontally flow in the general direction 5 (as shown in FIG. 1) the carbon feed 1 (relative to the direction of gravity) from a first location (e.g., inlet 3) to a second location (e.g., outlet 6). The gas 4 may be provided in the reactor to help inhibit back-mixing of the feed 1.

Back-mixing generally refers to the tendency of feed that is more processed or has had a longer residence time in the reactor to intermingle or blend with feed that is less processed or has had a shorter residence time in the reactor. If back mixing were present, it would result in feed reaching the reactor outlet with components that have different residence times. If not minimized or inhibited, back-mixing could lower purified carbon production rates and/or product quality (e.g.,. the purity of the carbon). For example, back mixing could result in requiring a slower feed rate in the reactor to ensure that all material emerging from the outlet of the reactor at any one time has had a minimum residence time in the reactor to at least be at a threshold desired purity level. Despite a portion of that feed just meeting the minimum residence time, another portion of that feed may far exceed that minimum residence time, thereby being inefficient. Such back-mixing is more likely to result in a conventional circular cross-section stirred fluid bed reactor, for example. Use of such a conventional stirred fluid bed reactor could result in a wide distribution of carbon particle residence times in the reactor. The wide particle residence times would inhibit achieving a high-purity carbon in a single-pass with the reactor.

The gas 4 may be provided into the reactor 2 at an angle and/or velocity sufficient to help move the carbon feed 1 through the reactor, including horizontally relative to the direction of gravity in the direction 5. The angle at which the gas 4 is provided may also help minimize or inhibit back-mixing of the carbon feed 1. For example, providing the gas 4 into the reactor 2 at an angle relative to vertical may help move the feed 1 forward (e.g., from the inlet 3) in approximately the same direction as the gas 4, thereby helping to minimize backward movement of the feed 1 and thus minimizing or inhibiting back-mixing. Said angle may be between about 0 to about 90 degrees, or between about 10 to about 40 degrees, or about 15 to about 35 degrees, or about 20 to about 30 degrees, or about 20 degrees. The velocity at which the gas 4 is provided into the reactor 2 may be in a range of about 30 to about 130 m/s, or about 50 to about 130 m/s, or about 70 to about 130 m/s, or about 90 to about 130m/s, or about 110 to about 130 m/s. In some embodiments, the velocity at which the gas is provided may be sufficient to fluidize the carbon feed 1. A fluidizing gas may be a gas with a sufficiently high velocity to fluidize the carbon feed 1. The gas 4 itself may be an inert non-toxic gas, such as nitrogen (N₂). The gas 4 may comprise a reacting gas, such as carbon monoxide (CO) or chlorine gas (Cl₂). A reacting gas is one that may react with certain impurities in a feed, to help facilitate their removal from said feed. The gas 4 may be introduced to the reactor via a gas inlet 7, and may be provided into the reactor via a gas distribution plate 8. The gas 4 may be provided into the reactor 2 from below the feed 1. Alternatively, the gas 4 may be provided into the reactor 2 from a side. The gas 4 may exit the reactor 2 via gas outlet 10.

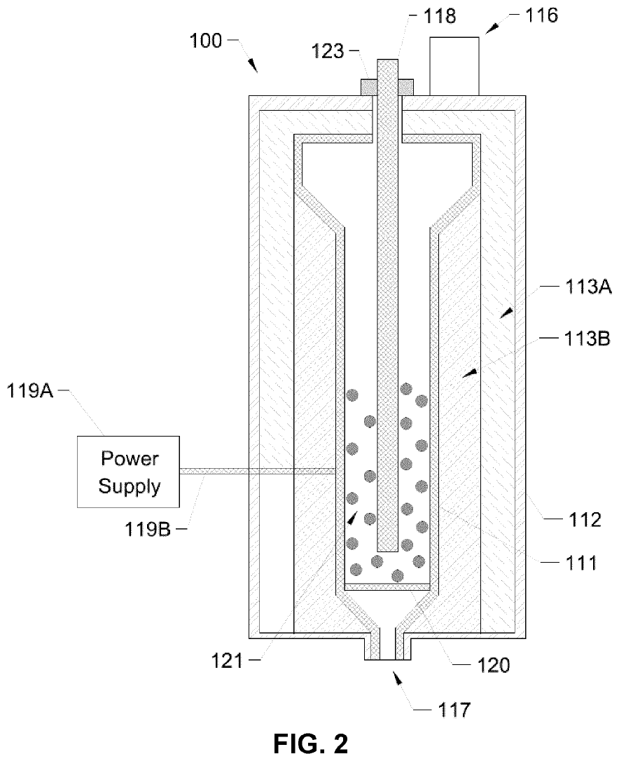

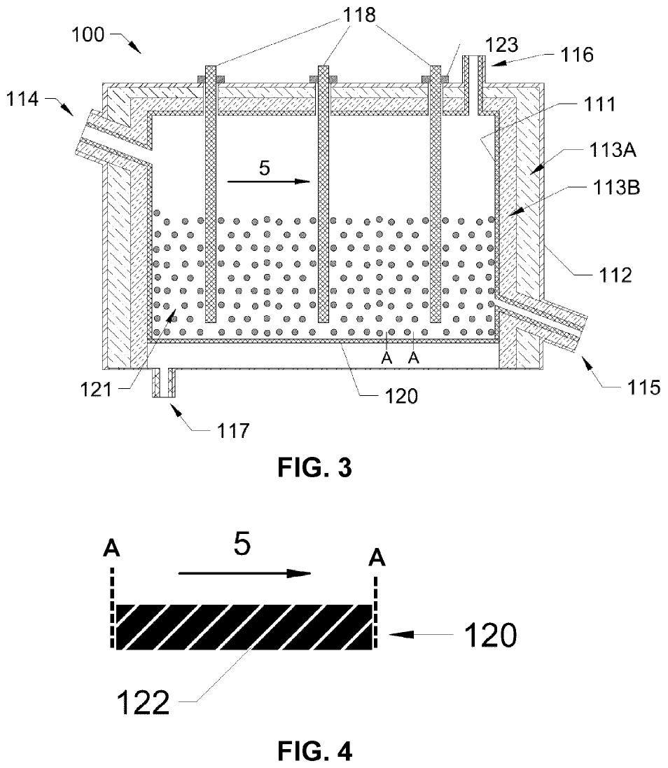

The process comprises heating the carbon feed 1 using the electrode to approximately 2500° C. The carbon feed 1 may heated, for example, to approximately 2800° C., or approximately 3000° C. The carbon feed 1 is heated electrothermally using one or more electrodes (as shown in FIGS. 2 and 3) within the reactor 2, where the high temperatures are used to volatilize the impurity in the carbon feed 1. In an embodiment, the electrode(s) may be configured to help minimize or inhibit back-mixing of the carbon feed 1. The electrode 118 may extend vertically into the reactor 2, acting to break up, or partially compartmentalize the reactor 2 such that the carbon feed 1 must move around or under the electrode 118 as it horizontally flows through the reactor 2. As a result, the electrode 118 may act as a partial backstop, physically blocking or creating back pressure to the carbon feed 1 to help prevent it from flowing backwards and back-mixing with less processed feed. Less processed feed refers to feed that has been resident within the reactor for less time.

The process comprises continuously horizontally flowing in the general direction 5 the carbon feed 1 through the reactor 2 for a threshold residence time to volatilize a sufficient amount of impurity in the carbon feed 1 to form a carbon material 9 with a select purity. As each portion of the feed 1 horizontally flows through the reactor 2, the impurity in that portion is volatilized and removed from the feed 1 at the high temperatures, and is purged from the reactor along with the gas 4 via a gas outlet 10 in the reactor 2. The high aspect ratio of the reactor 2, coupled with the horizontally-induced flow in the general direction 5 of the feed 1, provides the carbon feed 1 with a sufficiently long residence time at the high, volatilizing temperatures of the electrothermal reactor 2 to form a purified carbon material 9 with only one pass of the feed 1 through the reactor 2 as part of a continuous process. A purified carbon material refers to a carbon material having a lower concentration of impurities than the original carbon feed provided into the reactor. The high aspect ratio of the reactor 2, coupled with the feed's horizontally-induced flow and minimized or inhibited back-mixing, results in the concentration of purified carbon material increasing over the length of the reactor 2 as impurities are volatilized, and facilitates formation of the purified carbon material 9 with only one pass of the feed through the reactor 2 as part of a continuous process.

The residence time of the carbon feed 1 through the reactor 2 may be further controlled by adjusting any one or more of the (i) rate at which the carbon feed 1 is fed into the reactor 2; (ii) rate at which the carbon material 9 is discharged from the reactor 2; and/or (iii) velocity at which the gas 4 is provided into the reactor 2. Lower feed rates, discharge rates, and/or gas velocities may result in a lower rate of horizontal flow in the general direction 5 of the carbon feed 1 through the reactor 2, thereby increasing the amount of time the feed 1 is subjected to the high, volatilizing temperatures of the electrothermal reactor 2. By contrast, higher feed rates, discharge rates, and/or gas velocities may result in a higher rate of horizontal flow 5, thereby decreasing the amount of time the feed 1 is subjected to the high temperatures. As a result, residence time of the carbon feed 1 may be controlled through such parameters to suit the type and/or impurity level of the carbon feed, and the desired purity level of the resulting carbon. For example, if the carbon feed 1 is already substantially pure, the residence time of the feed 1 through the reactor 2 may be lowered by having a higher feed rate, discharge rate, and/or gas velocity. Alternatively, if the carbon feed is substantially impure (e.g., about 20% impurities/non-carbon materials), the residence time of the feed may be lower by having a lower feed rate, discharge rate, and/or gas velocity. In a continuous process, the purity level of the carbon feed may vary over time. Accordingly, the residence times for specific portions of feed may be continuously controlled adjusting the feed rate, discharge rate, and/or gas velocity to suit the specific portion of feed passing through the reactor at that time. The feed entering the reactor and/or the purified carbon material exiting the reactor may be sampled to assess their purity. The feed rate, discharge rate, and/or gas velocity may be controlled based on the purities of the sampled feed and/or purified carbon materials.

As a final step, the process comprises discharging the purified carbon material 9. The purified carbon material 9 is discharged from the reactor 2 via the outlet 6, at which point it may be collected and either further processed or incorporated into a final product. The carbon material 9, so purified, may have a purity of about 99% or more than 99%. In some embodiments, the purified carbon material 9 may be graphite having a purity of about 99.95% or greater than 99.95%. In some embodiments, the purified carbon material 9 is battery-grade graphite, and may be used in battery production (e.g., lithium-ion batteries).

In some embodiments, the process is a continuous process. In some embodiments, the process can generate approximately 5000 tons per year of purified carbon material 9. In some embodiments, the process can generate approximately 5000 tons per year of purified carbon material 9 when the residence time of the carbon feed 1 in the reactor 2 is about 1 hour.

Further, in some embodiments of the process, the reactor 2 is a compartmentalized plug-flow electrothermal reactor.

FIGS. 2 and 3 show an embodiment of an electrothermal reactor 100 for helping remove impurities from carbon in accordance with an embodiment of the present invention. The reactor 100 comprising a crucible 111 with a length and a width, the length being larger than the width (also referred to herein as a high length-to-width aspect ratio). The length is always the longer of the two horizontal-plan dimensions. The crucible 111 may have a length to width ratio of between about 3:1 to about 10:1, or about 4:1 to about 10:1, or about 5:1 to about 10:1, or about 6:1 to about 10:1, or about 7:1 to about 10:1, or about 8:1 to about 10:1, or about 9:1 to about 10:1. In an embodiment, the crucible 111 has a length to width ratio of about 4:1. In one or more embodiments, the crucible 111 may have a length of 2 m and a width of 0.5 m; and the reactor 100 may have a length of 3 m and a width of 1 m. In other embodiments, the crucible 111 may have a height of 1.5 m, and the reactor 100 may have a height of 2.5 m. In one or more embodiments, the crucible 111 may have a rectangular cross-section. In one or more embodiments, the reactor 100 may have a rectangular cross-section.

The reactor 100 further comprises an outer shell 112 that encases insulating layers 113A, B, where the thermal insulating 113A and electrical isolating layers 113B surround the crucible 111. The crucible 111 may be comprised of a purified carbon material to minimize introduction of impurities/non-carbon materials from the crucible 111, itself, into the carbon feed within the reactor 100. In some embodiments, the outer shell 112 is composed of metal, such as steel; and the insulating layers 113A, B comprise thermally insulating and/or electrically isolating refractory layers. The crucible 111 comprises an inlet 114 positioned at a first location along its length for receiving a carbon feed into the crucible 111, and an outlet 115 positioned at a second location along its length for discharging purified carbon material from the crucible 111. The crucible 111 further comprises a gas outlet 116 positioned at a third location along its length for discharging gasses from the crucible 111, and a gas inlet 117 positioned at the bottom of the crucible 111 for providing a gas into the crucible. In some examples, there is a second gas outlet (not shown) for discharging gasses from the crucible 111 should the first gas outlet 116 become clogged.

The reactor also comprises electrodes 118 extending into the crucible 111. The electrodes 118 may be positioned between the first location and the second location. The electrodes 118 receive an electrical current which heats the carbon feed to a temperature sufficiently high to volatize impurities, such as greater than 2500° C. In some embodiments the electrodes 118 may receive direct current (DC), in some embodiments the electrodes 118 may receive alternating current (AC). The electrode 118 may extend to a pre-determined distance from the bottom. The electrode 118 may extend substantially vertically into the crucible 111. By extending into the crucible 111, the electrodes 118 may divide the crucible volume into two or more compartments, thereby compartmentalizing the reactor. Further, electrodes 118 may be cylindrical-shaped, or rectangular cuboid-shaped. In one or more embodiments, there is two or more, or three or more electrodes 118, as shown in FIGS. 2 and 3. When there are two or three electrodes 118, the electrodes 118 may divide the crucible volume into three or more, or four or more compartments, thereby helping to partially compartmentalize the reactor.

In some embodiments, there is only one electrode 118. In some embodiments, the crucible 111 may act as an electrode. In some embodiments the crucible 111 may be connected to a power supply 119A via an electrical connection 119B. Further, when acting as an electrode, the crucible 111 may be grounded. When the crucible 111 is connected to a power supply 119A with an electrical connection 119B, the electrical connection 119B may an electrode or a ground. In some embodiments, there are a plurality of electrodes 118, such as two or more, or three or more electrodes. When there is more than one electrode 118, the crucible 111 does not need to act as the second electrode, and the multiple electrodes 118 can act as either AC or DC electrodes. When there are two or more, or three or more electrodes, the electrodes may be aligned relative to each other; or the electrodes may be offset relative to each other (e.g., in a zig-zag pattern). There may be an electrical isolation collar 123 around the electrode for the purpose of electrical isolation. The electrical isolation collar 123 may also comprise a seal. The electrical isolation collar 123, may also serve to hold the electrode or limit its movement.

The reactor 100 may further comprise a gas distribution plate 120. The gas distribution plate 120 may be located at the bottom of the crucible 111, the gas distribution plate 120 may be configured to provide a gas into the crucible 111 to help cause a carbon feed to travel in a direction from the first location to the second location along the length of the crucible 111. Alternatively, the gas distribution plate 120 may be located at one or more sides of the reactor.

FIG. 4 depicts a magnified portion of the gas distribution plate 120 of FIG. 3 between cut lines A-A. The gas distribution plate 120 may be configured to provide the gas into the crucible 111 at a select angle. The select angle may be between 0 degrees and 90 degrees relative to the vector defined by the length-wise axis of the reactor. The select angle may be relative to a vector from the first location to the second location. The angle may be selected such that it helps reduce back-mixing of the carbon feed as it travels from the first location to the second location. To provide the gas at a select angle, the gas distribution plate 120 may define a plurality of apertures 122 (as shown in FIG. 3), where said apertures 122 may have an orientation that is angled relative to a plane defined by the plate. The apertures 122 pass through the entirety of the plate 120. The angles of the apertures 120 may be the same as the select angle at which the gas is provided into the crucible 111. In some embodiments, the angled orientation of the apertures 122 helps cause the carbon feed to travel in the general direction 5 (as shown in FIG. 1). In some embodiments, the apertures 122 have an orientation that is angled between about 0 to about 90 degrees, or between about 10 to about 40 degrees, or about 15 to about 35 degrees, or about 20 to about 30 degrees, or about 20 degrees.

The crucible 111 may be formed by machining the crucible 111 from a single block of material such as a carbon block. The crucible 111 may be formed by multiple-piece construction, where the reactor pieces are pressed (e.g., not welded) into place, such that molten sections of the reactor pieces are pressed and sealed together.

In some embodiments, the present electrothermal reactor 100 may be used in producing a purified carbon material via the process described herein. In use, a carbon feed 121 is provided into the crucible 111 of the reactor via the inlet 114; a gas is provided into the crucible 111 via the gas inlet 117 and the gas distribution plate 120; and a current is passed through the electrode 118 to heat the carbon feed 121 to a temperature that is sufficiently high to volatize at least some impurities, such as greater than 2500° C., or such as about 2800° C., or such as about 3000° C. The reactor 100 maintains this temperature. The insulating layers 113A, B and/or the outer shell 112 may help maintain this temperature within the reactor 100.

So provided into the crucible 111, the carbon feed 121 flows from the inlet 114 towards the outlet 115. The direction of flow of the carbon feed 121 may have a horizontal component. The horizontal flow of the carbon feed 121 may be induced by the high length to width aspect ratio of the crucible 111; the angle at which the gas is provided into the crucible 111 via the gas distribution plate 120; and/or the velocity at which the gas is provided via the gas inlet 117.

During the feed's horizontal flow through the crucible 111, back-mixing of the carbon feed 121 may be inhibited. Back-mixing may be inhibited in part due by the angled gas flow, and/or the presence of the electrode(s) 118, and/or due to the reactor having a length that is greater than its width, and/or by causing the feed flow in a generally horizontal direction relative to the direction of gravity. In an embodiment the reactor is configured to cause the feed to flow in a generally horizontal direction relative to gravity. To accomplish this, the reactor 100 may have the inlet 114 and outlet 115 positioned at similar elevations, but spaced horizontally apart by a select distance. The angled gas flow may help induce a directional flow where the carbon feed 121 moves from the inlet 114 in approximately the same direction as the angled gas flow, thereby minimizing backward movement of the feed and thus minimizing back-mixing. In cooperation with the angled gas flow, the electrode(s) 118 may help to divide, or partially compartmentalize, the crucible 111 volume, such that the carbon feed 121 must move around or under the electrode 118 as it horizontally flows through the crucible 111. As a result, the electrode 118 may act as a backstop, physically blocking at least a portion of the carbon feed 121 from flowing backwards and back-mixing with itself.

As the carbon feed 121 horizontally flows through the crucible 111 with minimized back-mixing, impurities/non-carbon materials in the feed are volatilized at the high operating temperatures of the reactor 100. As the impurities volatilize, they are purged from the crucible 111 with the gas that flows from the gas inlet 117 to the gas outlet 116. As a result, the concentration of purified carbon material increases in a gradient-fashion over the length of the crucible 111 until reaching the discharge outlet 115 at the desired purity. The rate at which the carbon feed 121 flows through the crucible 111 can be controlled to either increase or decrease the residence time of the carbon feed 121 in the crucible 111, depending on the type or impurity level of the carbon feed 121 and/or the desired purity level of the discharged carbon feed. For example, the residence time of the feed can be controlled by adjusting feed and discharge rates, and/or the velocity at which the gas is provided into the crucible 111. Such parameters may be continuously controlled and varied over a period of time.

The high aspect ratio of the crucible 111 enables the use of a single vessel instead of multiple smaller reactors in series. A single vessel reactor may help avoid the use of multiple smaller reactors that would need to use a slower semi-batch process, and may help avoid the challenges of transferring high-temperature fluidized carbon between smaller reactors. So purified in accordance with the present disclosure, the carbon material may have a purity of about 99% or more than 99%. For example, in one or more embodiments where the crucible 111 has a length of 2 m and a width of 0.5 m, every 0.5 m of length may be approximately equivalent to a stirred reactor, such that one reactor 100 may have the same throughput capacity as 4 stirred reactors in series.

In some embodiments, the carbon feed 121 may be graphite, and the purified carbon material may be graphite having a purity of about 99.95% or greater than 99.95%. In some embodiments, the purified carbon material is battery-grade graphite, and may be used in battery production; for example, in producing lithium-ion batteries. In some embodiments, where the carbon feed is graphite, the crucible-when acting as the second electrode-may be formed of high purity graphite. Further, in some examples, the reactor is a compartmentalized plug-flow electrothermal reactor.

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A process for removing impurities from a carbon material, the process comprising:
providing the carbon material as a carbon feed into an electrothermal reactor at a first location;
providing a gas into the reactor;
passing the carbon feed from a first location to a second location in the reactor and inhibiting back-mixing of the feed for a feed residence time sufficient to volatize at least some non-carbon material in the feed;
heating the carbon feed using one or more electrodes to volatize at least some non-carbon material to produce a purified carbon material; and
discharging the purified carbon material at the second location.

2. The process of claim 1, wherein the carbon feed is continuously provided into the first location of the reactor, and the purified carbon material is continuously discharged from the second location of the reactor.

3. The process of any one of claims 1 to 2, wherein the electrothermal reactor has a high aspect length-to-width ratio.

4. The process of any one of claims 1 to 3, wherein providing a gas comprises providing the gas into the reactor at an angle and/or velocity sufficient to help move the carbon feed through the reactor horizontally relative to gravity.

5. The process of any one of claims 1 to 4, wherein providing the gas comprises providing the gas into the base of the reactor.

6. The process of any one of claims 1 to 5, wherein providing a gas comprises providing the gas at an angle sufficient to help inhibit back-mixing of the carbon feed.

7. The process of any one of claims 4 to 6, wherein the gas is provided into the reactor at an angle that is between 0 to about 90 degrees relative to the vector defined by the length-wise axis of the reactor.

8. The process of any one of claims 1 to 7, wherein the gas is provided into the reactor at a velocity in a range of about 30 to about 130 m/s.

9. The process of any one of claims 1 to 8, wherein the gas is a fluidizing gas.

10. The process of any one of claims 1 to 9, wherein passing the carbon feed from a first location to a second location in the reactor comprises passing the carbon feed in a direction that is generally horizontal relative to the direction of the force of gravity.

11. The process of any one of claims 1 to 10, wherein the carbon feed is a graphite feedstock.

12. The process of claim 11, wherein the purified carbon material has a purity of about 99% or more than 99%.

13. The process of any one of claims 1 to 12, wherein the gas is an inert gas or a reactive gas.

14. The process of any one of claims 1 to 13, wherein the carbon feed is heated to approximately 1,400° C. to 3,000° C.

15. The process of any one of claims 1 to 14, wherein the non-carbon impurity material comprises silica, iron, alumina, or a combination thereof.

16. The process of any one of claims 1 to 15, wherein the reactor is compartmentalized.

17. The process of any one of claims 1 to 16, wherein the electrothermal reactor is a compartmentalized plug-flow electrothermal reactor.

18. The process of claim 16 or 17, wherein the compartmentalization is sufficient to minimize back-mixing of the carbon feed.

19. An electrothermal reactor comprising:
a crucible, the crucible comprising a length and a width, the length being larger than the width;
an inlet at a first location in the crucible along the length for receiving a carbon feed into the crucible;
an outlet at a second location in the crucible along the length for discharging a purified carbon feed from the crucible;
a gas outlet for discharging a gas from the crucible;
an electrode for receiving a current to heat the carbon feed; and
a gas distribution plate in a bottom of the crucible, the gas distribution plate configured to provide a gas into the crucible.

20. The reactor of claim 19, wherein the electrode extends into a cavity defined by the crucible, the cavity containing the carbon feed.

21. The reactor of any one of claims 19 to 20, wherein the electrode extends into the cavity of the crucible, the electrode positioned between the first location and the second location.

22. The reactor of any one of claims 19 to 21, comprising a plurality of electrodes.

23. The reactor of claim 22, wherein at least one of the electrodes extends into the cavity of the crucible.

24. The reactor of any one of claims 19 to 23, wherein the gas distribution plate is configured to provide gas into the crucible to cause the carbon feed to travel in a direction from the first location to the second location.

25. The reactor of any one of claims 19 to 24, wherein the gas distribution plate is configured to provide the gas into the crucible at an angle.

26. The reactor of any one of claims 19 to 25, wherein the gas distribution plate is configured to help inhibit back-mixing of the feed as it travels from the first location to the second location.

27. The reactor of any one of claims 19 to 26, wherein the gas distribution plate defines a plurality of apertures.

28. The reactor of claim 27, wherein the apertures have an orientation that is angled relative to a plane defined by the plate.

29. The reactor of any one of claims 27 to 28, wherein the apertures have an orientation that is angled at 0 to about 90 degrees, or about 45 degrees, from the vector defined by the length-wise axis of the reactor.

30. The reactor of any one of claims 19 to 29, wherein the electrode(s) extend vertically into the cavity defined by the crucible.

31. The reactor of claim 30, wherein the electrode(s) divide the crucible volume into two or more compartments.

32. The reactor of any one of claim 30 or 31, wherein the electrode(s) extend vertically into the cavity defined by the crucible to a pre-determined distance from the bottom of the crucible.

33. The reactor of any one of claims 19 to 32, wherein the electrode(s) are cylindrically shaped, or rectangular cuboid-shaped.

34. The reactor of any one of claims 19 to 33, wherein the interior of the crucible has a high aspect length-to-width ratio.

35. The reactor of any one of claims 19 to 34, wherein the crucible has a length-to-width ratio of about 3:1 to about 10:1, or about 4:1.

36. The reactor of any one of claims 19 to 35, wherein the crucible is the electrode.

37. The reactor of claim 36, wherein the crucible is formed of graphite having a purity of about 99% or more than 99%.

38. The reactor of any one of claims 19 to 37, wherein the reactor is a compartmentalized plug-flow electrothermal reactor.

39. Use of a compartmentalized plug-flow electrothermal reactor to purify a graphite feed.

40. The use of claim 39, wherein the feed is purified to about 99.95%.
